(19) United States
(12) Patent Application Publication
(10) Pub. No.: US 2021/0065178 A1
(43) Pub. Date: Mar. 4, 2021

(54) CONTROLLING USAGE OF AN ELECTRONIC PAYMENT ACCOUNT

(71) Applicant: INTERNATIONAL BUSINESS MACHINES CORPORATION, ARMONK, NY (US)

(72) Inventors: Mary E. Rudden, Denver, CO (US); Adam Lee Griffin, Dubuque, IA (US); Shikhar Kwatra, Durham, NC (US); Melissa Restrepo Conde, Raleigh, NC (US); William G. Dusch, Morrisville, NC (US); John Wissing, Dubuque, IA (US)

(21) Appl. No.: 16/553,424

(22) Filed: Aug. 28, 2019

(51) Int. Cl. G06Q 20/40; G06N 20/00

(52) U.S. Cl. CPC G06Q 20/401; G06N 20/00

(57) ABSTRACT

An approach is provided for granting a security permission to a payment account. A relationship between an owner of an account and a user is determined by using a knowledge graph. A pattern of purchases made by the user is determined by using a machine learning module. Based on (i) the relationship between the owner of the account and the user and (ii) the pattern of the purchases, a security permission is dynamically granted to the user for a usage of the account.

### BACKGROUND

The present invention relates to payment management, and more particularly to granting a security permission to use a payment account.

Electronic payment methods include using credit cards, digital wallets (i.e., e-wallets), cryptocurrency, online payment systems that support online money transfers, and other means of procuring expenditures via electronic monetary transactions. A process of adding an authorized user to a payment card or electronic form of payment satisfies onboarding requirements and security requirements that address security concerns that encapsulate the creditor and borrower as responsible parties. There are many relationships in finance that authorize a “vouch-for” credit relationship of others, such as co-borrowers and co-signers on a loan or line of credit.

### SUMMARY

In one embodiment, the present invention provides a computer-implemented method. The method includes determining, by one or more processors, a relationship between an owner of an account and a user by using a knowledge graph. The method further includes determining, by the one or more processors, a pattern of purchases made by the user by using a machine learning module. The method further includes based on (i) the relationship between the owner of the account and the user and (ii) the pattern of the purchases, dynamically granting, by the one or more processors, a security permission to the user for a usage of the account.

In another embodiment, the present invention provides a computer program product which includes a computer readable storage medium having computer readable program code stored on the computer readable storage medium. The computer readable program code is executed by a central processing unit (CPU) of a computer system to cause the computer system to perform a method. The method includes the computer system determining a relationship between an owner of an account and a user by using a knowledge graph. The method further includes the computer system determining a pattern of purchases made by the user by using a machine learning module. The method further includes based on (i) the relationship between the owner of the account and the user and (ii) the pattern of the purchases, the computer system dynamically granting a security permission to the user for a usage of the account.

In another embodiment, the present invention provides a computer system including a central processing unit (CPU); a memory coupled to the CPU; and a computer readable storage medium coupled to the CPU. The computer readable storage medium contains instructions that are executed by the CPU via the memory to implement a method. The method includes the computer system determining a relationship between an owner of an account and a user by using a knowledge graph. The method further includes the computer system determining a pattern of purchases made by the user by using a machine learning module. The method further includes based on (i) the relationship between the owner of the account and the user and (ii) the pattern of the purchases, the computer system dynamically granting a security permission to the user for a usage of the account.

### BRIEF DESCRIPTION OF THE DRAWINGS

FIG. 1 is a block diagram of a system for controlling usage of a payment account, in accordance with embodiments of the present invention.

FIG. 2 is a flowchart of a process of controlling usage of a payment account, where the process is implemented in the system of FIG. 1, in accordance with embodiments of the present invention.

FIG. 3 is an example of controlling usage of a payment account using the process of FIG. 2, in accordance with embodiments of the present invention.

FIG. 4 is a block diagram of a computer included in the system of FIG. 1 and that implements the process of FIG. 2, in accordance with embodiments of the present invention.

### DETAILED DESCRIPTION

### Overview

When adding an authorized user to a payment card or an electronic form of payment using known payment account management techniques, satisfying onboarding requirements is a tedious, time-consuming process. Known payment account management techniques lack a secure or controlled means to delegate spending privileges to any additional user of an electronic payment account. As used herein, an electronic payment account is an account that provides payments by an electronic payment method. An electronic payment account is also referred to herein as simply a “payment account” or an “account.”

Embodiments of the present invention address the aforementioned unique challenges of managing a payment account by automatically authorizing temporarily delegated users to use payment accounts (e.g., credit lines, tokenized versions of electronic payments, or digital wallets) in a trusted user relationship, with automatically determined restrictions in place. The payment accounts provide for forms of payment that include credit cards, digital wallets, online money transfer systems, cryptocurrency, and other electronic means of making expenditures via monetary transactions.

Embodiments of the present invention retrieves and correlates profile and credential information of a payment account owner with the owner's calendar information and/or real-time geolocation to determine or predict a need for the owner to authorize an additional user to use the payment account according to financial fence usage restrictions. In one or more embodiments, the usage restrictions include one or more of the following: (1) a period of time during which the additional user is authorized to use the payment account, (2) spending cap(s) per specified time period(s), (3) specified item(s) and/or specified category(ies) of items that the additional user is permitted to purchase using the payment account, and (4) business(es) (e.g., physical stores and/or e-commerce websites) at which the additional user is permitted to make purchases using the payment account.

For example, a payment account usage control system described herein analyzes Internet of Things sensor feeds and calendar information of a parent to determine that the parent has a business trip scheduled for next week and the parent has mentioned that the parent's child will be home alone during the business trip. Based on historical purchase information, the system determines that the child will need to make purchases of groceries and gas during the time of the business trip and further determines a spending cap that will accommodate the likely gas and grocery purchases by the child. The system automatically authorizes the child's usage of the credit card during the week of the business trip to make purchases of groceries and gas. During the week of the business trip, in response to the child using the credit card to initiate a purchase of an item that would exceed the spending cap or that is not in the category of groceries or gas, the system sends a notification to the parent about the initiated purchase exceeding the spending cap or not being groceries or gas. In response to the notification, the parent can send an instruction to the system to authorize the purchase.

### System for Controlling a Usage of a Payment Account

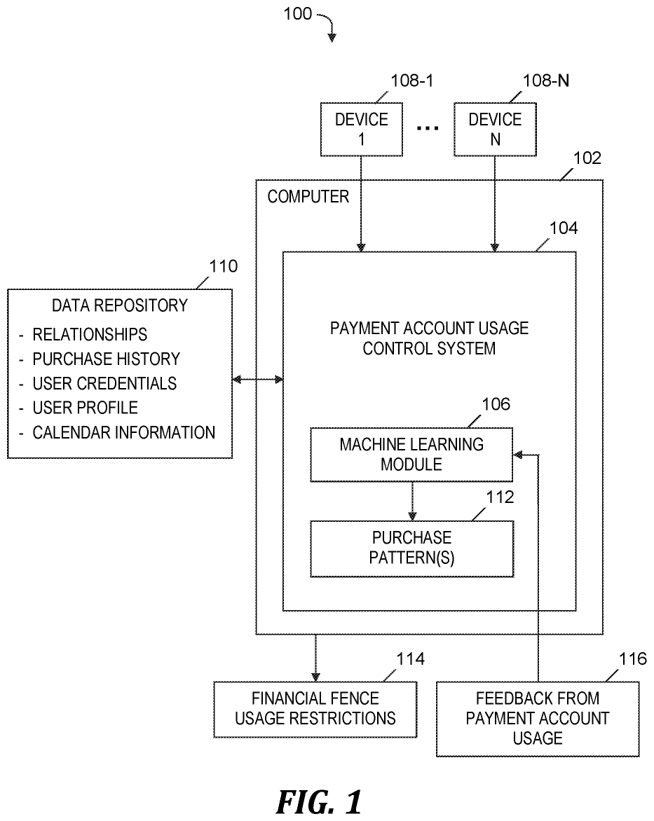

FIG. 1 is a block diagram of a system 100 for controlling usage of a payment account, in accordance with embodiments of the present invention. System 100 includes a computer 102, which executes a software-based payment account usage control system 104, which includes a machine learning module 106 (e.g., a region convolutional neural network (R-CNN) machine learning module). Computer 102 is operatively coupled via a computer network (not shown) with device 108-1, . . . , device 108-N, which are computing devices. For example, devices 108-1, . . . , 108-N include Internet of Things (IoT) devices or mobile devices.

Devices 108-1, . . . , 108-N send user credentials and a user profile of an owner of a payment account to payment account usage control system 104, which stores the user credentials and user profile in a data repository 110 (e.g., a cloud repository). For example, the user credentials and profiles include biometric and facial features, information about users' computing devices, age of the users, family clusters of the users, and credit cards and digital wallets owned by the users, along with purchase history information about payments made and items purchased by the users over a specified time period. In one embodiment, devices 108-1, . . . , 108-N send information from the users' calendar services and geolocation information specifying the real-time location of the devices 108-1, . . . , 108-N to payment account usage control system 104. In one embodiment, payment account usage control system 104 permits the users to opt in and opt out of supplying the user credentials, user profiles, calendar information, and/or geolocation information to payment account usage control system 104.

Payment account usage control system 104 generates a knowledge graph (not shown) to represent relationships (e.g., familial relationship or friend relationship) between an owner of a payment account and other individuals (e.g., members of the owner's family or friends of the owner). In one embodiment, payment account usage control system 104 collects information about the owner of the payment account and the individuals related to the owner and represents the collected information in the knowledge graph. In one embodiment, the aforementioned collected information includes (1) the ages of the individuals related to the owner, (2) the spending habits and previous purchases made by the individuals with authorization from the owner of the payment account, (3) a period of time during which one or more individuals will be granted security permissions to access the payment account, where the period of time is based on an identified context of the owner derived from calendar information of the owner and/or other information received from devices 108-1, . . . , 108-N (e.g., speech information provided by IoT sensor feeds and analyzed by a natural language processing system), (4) financial assets owned by the owner of the payment account, (5) types of items previously purchased by the individuals with authorization from the owner of the payment account, and (6) the amounts spent on the respective types of items previously purchased by the individuals with authorization from the owner of the payment account. Payment account usage control system 104 stores the aforementioned relationships and the collected information in data repository 110. In one embodiment, payment account usage control system 104 permits the owner of the payment account and the individuals related to the owner to opt in and opt out of supplying the aforementioned collected information to payment account usage control system 104.

In one embodiment, machine learning module 106 derives a context of the owner of the payment account by correlating (i) the user credentials and user profile, (ii) the relationships between the owner and the other individuals, and (iii) calendar information of the owner of the payment account and/or real-time geolocation information about a computing device operated by the owner of the payment account. Machine learning module 106 analyzes the purchase history information, generates purchase pattern(s) 112 based on the analysis of the purchase history information, and repeatedly updates purchase patterns 112 over time based on newly acquired purchase history information.

Using the derived context and the purchase pattern(s) 112, payment account usage control system 104 generates a financial fence 114 which indicates usage restrictions on the payment account (i.e., restrictions on a usage of the payment account by an individual related to the owner of the payment account). In one embodiment, the financial fence 114 specifies (i) a time period during which the individual is permitted to use the payment account, (ii) a spending cap indicating a maximum amount that the individual is permitted to spend using the payment account during a specified duration of time, (iii) one or more items that the individual is permitted to purchase using the payment account during the specified time period, (iv) one or more categories of items in which the individual is permitted to make purchases using the payment account during the specified time period, and (v) one or more businesses from which the individual is permitted to purchase items using the payment account during the specified time period. In other embodiments, the financial fence 114 consists of combinations of items (i) through (v) listed in this paragraph.

Machine learning module 106 receives feedback from payment account usage 116, where the feedback includes information about purchases by authorized individuals using the payment account and attempted purchases by authorized individuals, where the attempted purchases are outside the usage restrictions specified by the financial fence 114 (e.g., an initiation of a purchase of an item at a cost that exceeds the spending cap). Machine learning module 106 uses the received feedback 116 to train and retrain a machine learning model that payment account usage control system 104 uses to update the financial fence 114 and determine whether a newly initiated purchase is permitted to be completed.

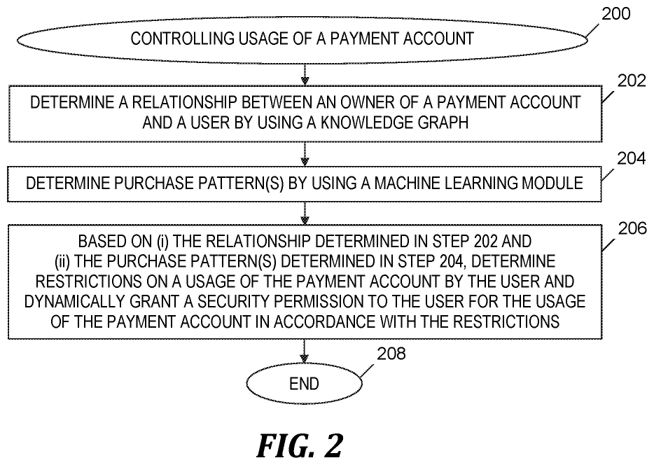

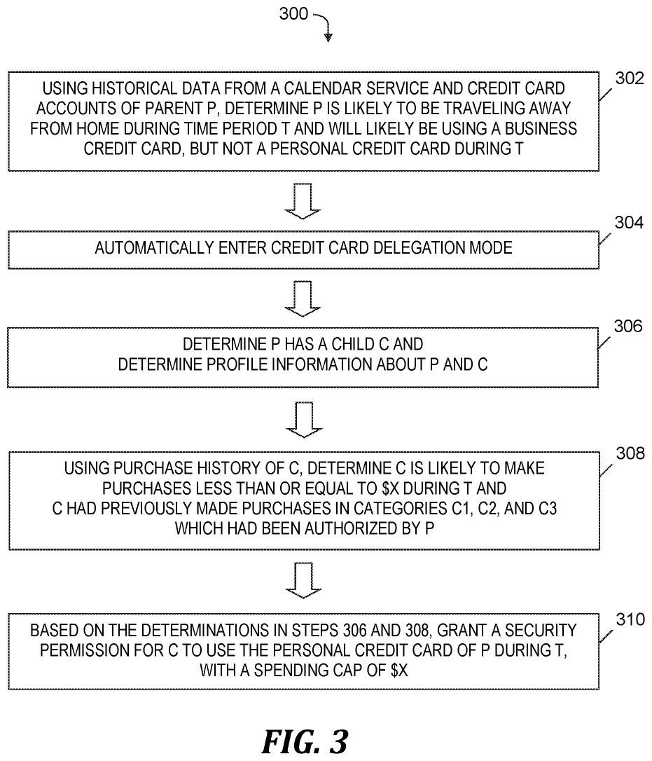

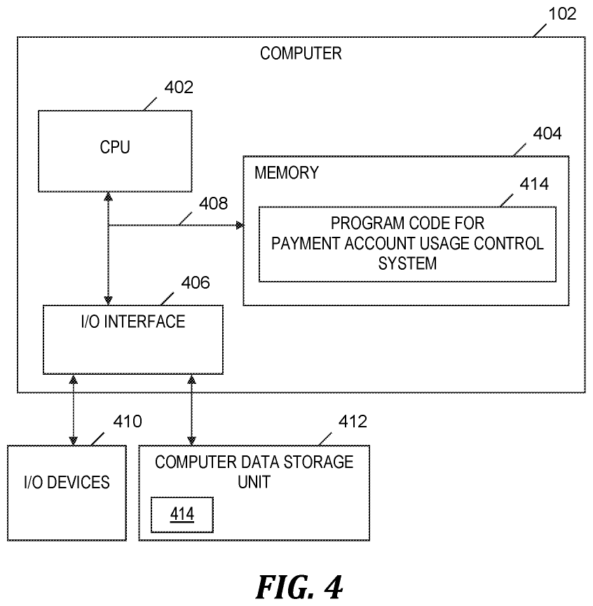

The functionality of the components shown in FIG. 1 is described in more detail in the discussion of FIG. 2, FIG. 3, and FIG. 4 presented below.

### Process for Controlling a Usage of a Payment Account

FIG. 2 is a flowchart of a process of controlling usage of a payment account, where the process is implemented in the system of FIG. 1, in accordance with embodiments of the present invention. The process of FIG. 2 starts at step 200. In step 202, payment account usage control system 104 (see FIG. 1) determines a relationship between an owner of a payment account and a user by using a knowledge graph that includes information stored in data repository 110 (see FIG. 1).

In step 204, payment account usage control system 104 (see FIG. 1) determines purchase pattern(s) 112 (see FIG. 1) (i.e., pattern(s) of purchases) by using machine learning module 106 (see FIG. 1). In one embodiment, payment account usage control system 104 (see FIG. 1) also uses the purchase history stored in data repository 110 (see FIG. 1) to determine purchase pattern(s) 112 (see FIG. 1) in step 204. In one embodiment, purchase pattern(s) 112 (see FIG. 1) include information specifying the user's spending habits, the user's previous purchases that were made using the payment account and with the authorization of the owner of the payment account, previous categories of items that were purchased by the user, and the amounts purchased in each of the categories.

In step 206, based on (i) the relationship determined in step 202 and (ii) the purchase pattern(s) determined in step 204, payment account usage control system 104 (see FIG. 1) determines financial fence usage restrictions 114 (see FIG. 1) (i.e., restrictions on a usage of the payment account by the user) and dynamically grants a security permission to the user for the usage of the payment account in accordance with the restrictions.

The process of FIG. 2 ends at step 208.

In one embodiment, step 206 includes payment account usage control system 104 (see FIG. 1) (i) determining one or more authorized categories of items that the user is authorized by the owner of the payment account to purchase based on purchase pattern(s) 112 (see FIG. 1); (ii) determining one or more authorized businesses from which the user is authorized by the owner of the payment account to purchase items based on purchase pattern(s) 112 (see FIG. 1); (iii) determining a maximum cost of one or more purchases that the user is authorized to make by the owner of the payment account; (iv) determining that the user is initiating a purchase of an item using the payment account; (v) determining that the item is an authorized category (i.e., a category included in the one or more authorized categories) and is being purchased from an authorized business (i.e., a business included in the one or more authorized businesses); (vi) determining that a cost of the purchase of the item does not exceed the maximum cost; and (vii) authorizing the purchase of the item by the user, based on the item being in the authorized category and being purchased from the authorized business, and further based on the cost of the purchase of the item not exceeding the maximum cost.

In one embodiment, payment account usage control system 104 (see FIG. 1) determines the one or more authorized categories, the one or more authorized businesses, and/or the maximum cost of the one or more purchases by using multivariate time series clustering.

In one embodiment, the process in steps (i) through (vii) listed above is extended to include payment account usage control system 104 (see FIG. 1) employing a reinforcement learning mechanism to perform the following steps: (viii) determining that a first cost of a first purchase initiated by the user using the payment account exceeds the maximum cost; (ix) responsive to the determination in step (viii), sending a notification to the owner of the payment account about the first cost exceeding the maximum cost; (x) receiving an authorization from the owner of the payment account to allow the user to complete the first purchase, where the authorization is generated in response to the notification; (xi) after receiving the authorization in step (x), determining that a second cost of a second purchase initiated by the user using the payment account exceeds the maximum cost; (xii) determining that the second cost matches the first cost (i.e., the first and second costs are equal or differ by no more than a specified amount); and (xiii) based on the authorization to complete the first purchase and the second cost matching the first cost, automatically authorizing a completion of the second purchase by the user event though the second cost exceeds the maximum cost, without sending another notification to the owner of the payment account, and without requiring an authorization by the owner of the payment account to allow the user to complete the second purchase.

In an alternative embodiment, steps (i) through (vii) listed above are modified by eliminating steps (iii) and (vi) and further eliminating the basis in step (vii) that includes the maximum cost.

In one embodiment, prior to step 206, payment account usage control system 104 (see FIG. 1) (i) by using machine learning module 106 (see FIG. 1), determines a context of the owner of the payment account based on data provided by IoT sensors and information from calendar service utilized by the owner; and (ii) based on the context of the owner, determines (1) a time period during which the usage of the payment account by the user is authorized and (2) a maximum amount the user is permitted to spend by using the payment account during the time period. In the embodiment described in this paragraph, the dynamically granting of the security permission to the user for usage of the payment account in step 206 is further based on the context of the owner of the payment account. System 100 (see FIG. 1) provides an option for the owner of the account to opt in and opt out of authorizing IoT sensors to provide the aforementioned data to payment account usage control system 104 (see FIG. 1).

In one embodiment, payment account usage control system 104 (see FIG. 1) uses machine learning module 106 (see FIG. 1) and a natural language processing service to analyze speech of the owner of the payment account received from IoT sensor feeds (e.g., records and analyzes utterances by the owner of the payment account about travel or authorizing usage of the owner's credit card), which derives a context of the owner. Payment account usage control system 104 (see FIG. 1) derives further context of the owner from receiving the owner's calendar information to determine whether the owner has scheduled an upcoming trip, meeting, etc. (or is currently traveling or attending a meeting), where the owner wants to authorize a family member to use the owner's credit card or other payment account for a time period during the duration of the trip, meeting, etc. In response to deriving the context of the owner of the payment account, payment account usage control system 104 (see FIG. 1) starts enabling and/or disabling restrictions on the user's usage of the payment account based in part on the relationship between the owner and the user. For example, the spouse of the owner can have a spending cap that is greater than the spending cap of a child of the owner.

In one embodiment, payment account usage control system 104 (see FIG. 1) determines the spending cap by using crowdsourced data or previous purchase pattern(s) 112 (see FIG. 1) of the user via multivariate time series clustering. For example, payment account usage control system 104 (see FIG. 1) applies a clustering algorithm that plots financial assets owned for a given age of the user when authorized to use the payment account against financial fence spending caps at a specific time slice. The clustering algorithm groups people with similar financial assets and spending caps as a function of time.

In addition to the spending cap, the financial fence 114 (see FIG. 1) includes, for example, restrictions specifying certain items that are permitted to be purchased, certain websites through which purchases are permitted to be made, payment portals that are permitted to be used for the purchases, etc.

Payment account usage control system 104 (see FIG. 1) provides the financial fence usage restrictions 114 (see FIG. 1) to the user, so that the user understands the upper limit on spending during specified time periods (e.g., per day, per week, etc.), together with the categories of items that are permitted to be purchased during a specified time period. In one embodiment, payment account usage control system 104 (see FIG. 1) makes purchase recommendations based on the user's purchase pattern(s) 112 (see FIG. 1). The purchase pattern(s) 112 (see FIG. 1) can be captured, for example, via a bidirectional long short-term memory (Bi-LSTM) model with a R-CNN machine learning network. For instance, in a scenario in which the owner is a parent who authorizes the parent's child to use a payment account for a week during which the parent is traveling and the child is remaining at home, payment account usage control system 104 (see FIG. 1) determines the basic needs of the child and generates a recommendation that includes specifying which groceries to order for a week until the parent returns from traveling and further includes links to websites through which the child is permitted to order groceries during the week and a listing of products that the child is permitted to purchase to meet the basic needs of the child.

In one embodiment, based on the analysis of the speech of the owner by the natural language processing system and/or analysis of the owner's calendar information, payment account usage control system 104 (see FIG. 1) determines that the owner of the payment account will likely travel to a location at which the owner will not be in a proximity to the user. In one embodiment, the aforementioned determination of the context of the owner is further based on the owner being likely to travel to the location not in proximity to the user. In one embodiment, step 206 is performed automatically, without any instruction provided by the owner of the payment account, based on the owner of the payment account being likely to travel to a location at which the owner will not be in a proximity to the user.

In one embodiment, payment account usage control system 104 (see FIG. 1) determines (i) x₁=an age of the user; (ii) x₂=a relationship between the owner of the payment account and the user as determined in step 202; (iii) x₃=previous purchases made by the user utilizing the payment account in response to previous grants of the security permission; (iv) x₄=a time period during which the usage of the payment account by the user is authorized; (v) x₅=an amount of financial assets owned by the owner of the account; and (vi) x₆=types of transactions completed by the user and historical amounts of each of the types of the transactions. Based on (i) through (vi) listed in this paragraph, payment account usage control system 104 (see FIG. 1) determines a maximum amount that the user is permitted to spend by using the payment account. In one embodiment, the dynamically granting of the security permission in step 206 includes granting a permission to the user to make purchases using the payment account with the restriction that the cost of the purchases must not exceed the maximum amount that the user is permitted to spend. System 100 provides an option to the owner of the payment account to opt in and opt out of having the aforementioned financial assets and the other information in parameters x₁ through x₆ be provided to payment account usage control system 104 (see FIG. 1).

In one embodiment, payment account usage control system 104 (see FIG. 1) uses reconfigurable weights applied to the parameters x₁ through x₆ listed above to predict whether the authorized user is permitted to make a purchase of a particular item. In one embodiment, the output of the sigmoid function shown in equation (1) presented below determines whether a purchase is permitted to be made given financial fence 114 (see FIG. 1) (e.g., an output of equation (1) lineated towards the value of 1), or whether the purchase is not permitted to be made given financial fence 114 (see FIG. 1) (e.g., an output equation (1) which equals 0).

Y=sigmoid function(w₁*x₁+w₂*x₂+w₃*x₃+w₄*x₄+w₅*x₅+w₆*x₆) (1)

In one embodiment, payment account usage control system 104 (see FIG. 1) uses historical data about the travel habits and other characteristics of the owner of the payment account to predict a time to activate the payment account delegation mode (i.e., a time to perform the process of FIG. 2). For example, payment account usage control system 104 (see FIG. 1) uses historical data about Henry's past travels to determine that Henry always travels during the last week of each month and that he uses only his business credit card during the travel time. Based on the determination about Henry, payment account usage control system 104 (see FIG. 1) automatically triggers the payment account delegation mode for the last week of the current month, without any prompting or instruction provided by Henry.

In one embodiment, payment account usage control system 104 (see FIG. 1) receives a spending cap from the owner of the payment account, where the spending cap applies to a secondary user of the payment account. At a point of sale during a transaction initiated by the secondary user, the usage of the payment account sends a SMS push message or an email push message to the mobile device of the owner. In response to receiving the message, the owner sends an approval of the transaction of the transaction via a multifactor authentication method.

For example, M and D's child H is 17 years old and remains at home while his parents are on vacation away from home. D is the primary user of a credit card. Doug has set a spending cap of $500 for H, who is the secondary user of the credit card. While M and D are on vacation, H contacts M and D to let them know that H is going to the grocery store to buy groceries. H gets grocery items and proceeds to the checkout, where all the items are scanned and total cost of the items is calculated. H swipes the credit card and payment account usage control system 104 (see FIG. 1) automatically sends an SMS push message to D's mobile device that there is a pending transaction awaiting D's approval. The SMS push message includes a list of the grocery items being purchased by H, so that D can review the items that D's child is purchasing. D activates an Approve button on the display on the mobile device to approve the transaction and permit the transaction to be completed.

### Example

FIG. 3 is an example 300 of controlling usage of a payment account using the process of FIG. 2, in accordance with embodiments of the present invention. In step 302 of example 300, using historical data from a calendar service used by a parent P and credit card accounts owned by P, payment account usage control system 104 (see FIG. 1) determines that P is likely to be traveling away from home during time period T and will likely be using a business credit card, but not a personal credit card during T.

In step 304, payment account usage control system 104 (see FIG. 1) automatically enters a credit card delegation mode based on the determinations made in step 302. Steps 302 and 304 precede step 202 (see FIG. 2).

In step 306, payment account usage control system 104 (see FIG. 1) determines that P has a child C and determines profile information about P and C. Step 202 (see FIG. 2) includes step 306.

In step 308, using purchase history of C, payment account usage control system 104 (see FIG. 1) determines that C is likely to make purchases less than or equal to $X during T and C had previously made purchases in categories C1, C2, and C3, which had been authorized by P. Step 204 (see FIG. 2) includes step 308.

Based on the determinations made in steps 306 and 308, payment account usage control system 104 (see FIG. 1) grants a security permission for C to use the personal credit card of P to make purchases in categories C1, C2, and/or C3 during T, with a spending cap of $X. Step 206 (see FIG. 2) includes step 310.

Although not shown in FIG. 3, example 300 may be extended with the time period T beginning after step 310 and C initiating a purchase of a first item in category C2 using the payment account, where the purchase of the first item keeps C's total purchases during T under the spending cap. Payment account usage control system 104 (see FIG. 1) automatically authorizes the completion of the purchase of the first item. Subsequent to the completion of the purchase of the first item, C initiates a purchase of a second item in a category C4 using the payment account, where C4 is different from C1, C2, and C3 (i.e., C4 is not a category approved by P for purchases made by C). Payment account usage control system 104 (see FIG. 1) automatically sends a notification to P about C's attempted purchase of the second item being in a non-approved category and provides P with options to authorize or not authorize the purchase of the second item. If P selects the option to authorize C's purchase of the second item in response to the notification, payment account usage control system 104 (see FIG. 1) completes C's purchase of the second item using the payment account.

### Computer System

FIG. 4 is a block diagram of a computer included in the system of FIG. 1 and that implements the process of FIG. 2, in accordance with embodiments of the present invention. Computer 102 is a computer system that generally includes a central processing unit (CPU) 402, a memory 404, an input/output (I/O) interface 406, and a bus 408. Further, computer 102 is coupled to I/O devices 410 and a computer data storage unit 412. CPU 402 performs computation and control functions of computer 102, including executing instructions included in program code 414 for a system that includes payment account usage control system 104 (see FIG. 1) to perform a method of controlling a usage of a payment account, where the instructions are executed by CPU 402 via memory 404. CPU 402 may include a single processing unit or be distributed across one or more processing units in one or more locations (e.g., on a client and server).

Memory 404 includes a known computer readable storage medium, which is described below. In one embodiment, cache memory elements of memory 404 provide temporary storage of at least some program code (e.g., program code 414) in order to reduce the number of times code must be retrieved from bulk storage while instructions of the program code are executed. Moreover, similar to CPU 402, memory 404 may reside at a single physical location, including one or more types of data storage, or be distributed across a plurality of physical systems in various forms. Further, memory 404 can include data distributed across, for example, a local area network (LAN) or a wide area network (WAN).

I/O interface 406 includes any system for exchanging information to or from an external source. I/O devices 410 include any known type of external device, including a display, keyboard, etc. Bus 408 provides a communication link between each of the components in computer 102, and may include any type of transmission link, including electrical, optical, wireless, etc.

I/O interface 406 also allows computer 102 to store information (e.g., data or program instructions such as program code 414) on and retrieve the information from computer data storage unit 412 or another computer data storage unit (not shown). Computer data storage unit 412 includes a known computer readable storage medium, which is described below. In one embodiment, computer data storage unit 412 is a non-volatile data storage device, such as, for example, a solid-state drive (SSD), a network-attached storage (NAS) array, a storage area network (SAN) array, a magnetic disk drive (i.e., hard disk drive), or an optical disc drive (e.g., a CD-ROM drive which receives a CD-ROM disk or a DVD drive which receives a DVD disc).

Memory 404 and/or storage unit 412 may store computer program code 414 that includes instructions that are executed by CPU 402 via memory 404 to control a usage of a payment account. Although FIG. 4 depicts memory 404 as including program code, the present invention contemplates embodiments in which memory 404 does not include all of code 414 simultaneously, but instead at one time includes only a portion of code 414.

Further, memory 404 may include an operating system (not shown) and may include other systems not shown in FIG. 4.

In one embodiment, computer data storage unit 412 includes data repository 110 (see FIG. 1).

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to controlling a usage of a payment account. Thus, an embodiment of the present invention discloses a process for supporting computer infrastructure, where the process includes providing at least one support service for at least one of integrating, hosting, maintaining and deploying computer-readable code (e.g., program code 414) in a computer system (e.g., computer 102) including one or more processors (e.g., CPU 402), wherein the processor(s) carry out instructions contained in the code causing the computer system to control a usage of a payment account. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of controlling a usage of a payment account.

While it is understood that program code 414 for controlling a usage of a payment account may be deployed by manually loading directly in client, server and proxy computers (not shown) via loading a computer-readable storage medium (e.g., computer data storage unit 412), program code 414 may also be automatically or semi-automatically deployed into computer 102 by sending program code 414 to a central server or a group of central servers. Program code 414 is then downloaded into client computers (e.g., computer 102) that will execute program code 414. Alternatively, program code 414 is sent directly to the client computer via e-mail. Program code 414 is then either detached to a directory on the client computer or loaded into a directory on the client computer by a button on the e-mail that executes a program that detaches program code 414 into a directory. Another alternative is to send program code 414 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 414 is transmitted to the proxy server and then it is stored on the proxy server.

Another embodiment of the invention provides a method that performs the process steps on a subscription, advertising and/or fee basis. That is, a service provider can offer to create, maintain, support, etc. a process of controlling a usage of a payment account. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 404 and computer data storage unit 412) having computer readable program instructions 414 thereon for causing a processor (e.g., CPU 402) to carry out aspects of the present invention.

The computer readable storage medium can be a tangible device that can retain and store instructions (e.g., program code 414) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 414) described herein can be downloaded to respective computing/processing devices (e.g., computer 102) from a computer readable storage medium or to an external computer or external storage device (e.g., computer data storage unit 412) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 414) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 414).

These computer readable program instructions may be provided to a processor (e.g., CPU 402) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 412) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 414) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer-implemented method comprising:
determining, by one or more processors, a relationship between an owner of an account and a user by using a knowledge graph;
determining, by the one or more processors, a pattern of purchases made by the user by using a machine learning module; and
based on (i) the relationship between the owner of the account and the user and (ii) the pattern of the purchases, dynamically granting, by the one or more processors, a security permission to the user for a usage of the account.

2. The method of claim 1, wherein the account is an electronic payment account, and wherein the dynamically granting the security permission includes:
determining one or more authorized categories of items that the user is authorized to purchase based on the pattern of the purchases and by using multivariate time series clustering;
determining one or more authorized businesses from which the user is authorized to purchase the items, based on the pattern of the purchases and by using the multivariate time series clustering;
determining that the user is initiating a purchase of an item using the electronic payment account;
determining that the item is in a category included in the one or more authorized categories and is being purchased from a business included in the one or more authorized businesses; and
based on the item being in the category included in the one or more authorized categories and the item being purchased from the business included in the one or more authorized businesses, authorizing the purchase of the item by the user.

3. The method of claim 2, further comprising:
determining, by the one or more processors, a maximum cost of one or more purchases that the user is authorized to make based on the pattern of the purchases and by using the multivariate time series clustering; and
determining, by the one or more processors, that a cost of the purchase of the item does not exceed the maximum cost, wherein the authorizing the purchase of the item by the user is further based on the cost of the purchase of the item not exceeding the maximum cost.

4. The method of claim 3, further comprising:
determining, by the one or more processors, that a first cost of a first purchase initiated by the user using the account exceeds the maximum cost;
in response to the determining that the first cost exceeds the maximum cost, sending, by the one or more processors, a notification to the owner of the account about the first cost exceeding the maximum cost;
receiving, by the one or more processors, an authorization from the owner of the account to allow the user to complete the first purchase, the authorization being in response to the notification;
subsequent to the receiving the authorization, determining, by the one or more processors, that a second cost of a second purchase initiated by the user using the account exceeds the maximum cost;
determining, by the one or more processors, that the second cost matches the first cost;
based on the authorization to complete the first purchase and the second cost matching the first cost, authorizing, by the one or more processors, a completion of the second purchase even though the second cost exceeds the maximum cost, without sending another notification to the owner of the account, and without requiring an authorization by the owner of the account to allow the user to complete the second purchase.

5. The method of claim 1, further comprising:
determining, by the one or more processors, a context of the owner of the account based on data from Internet of Things sensors and information from a calendar service of the owner of the account and by using the machine learning module; and
based on the context of the owner of the account, determining a time period during which the usage of the account by the user is authorized and a maximum amount that the user is permitted to spend during the usage of the account,
wherein the dynamically granting the security permission is further based on the context of the owner of the account.

6. The method of claim 5, further comprising determining, by the one or more processors, that an analysis of speech of the owner of the account by a natural language processing service and the machine learning module indicates that the owner of the account will likely travel to a location at which the owner of the account will not be in a proximity to the user, wherein the determining the context is further based on the owner being likely to travel to the location at which the owner will not be in the proximity to the user.

7. The method of claim 1, further comprising:
determining, by the one or more processors, an age of the user;
determining, by the one or more processors, previous purchases made by the user utilizing the account in response to previous grants of the security permission;
determining, by the one or more processors, a time period during which the usage of the account by the user is authorized;
determining, by the one or more processors, an amount of financial assets owned by the owner of the account;
determining, by the one or more processors, types of transactions completed by the user and historical amounts of each of the types of the transactions; and
based on the age of the user, the relationship between the owner of the account and the user, the pervious purchases made by the user, the time period during which the usage of the account by the user is authorized, the financial assets owned by the owner of the account, and the historical amounts of each of the types of the transactions, determining, by the one or more processors, a maximum amount that the user is permitted to spend during the usage of the account.

8. The method of claim 1, further comprising:
providing at least one support service for at least one of creating, integrating, hosting, maintaining, and deploying computer readable program code in the computer, the program code being executed by a processor of the computer to implement determining the relationship between the owner of the account and the user, determining the pattern of the purchases made by the user, and granting the security permission to the user for the usage of the account.

9. A computer program product comprising:
a computer readable storage medium having computer readable program code stored on the computer readable storage medium, the computer readable program code being executed by a central processing unit (CPU) of a computer system to cause the computer system to perform a method comprising the steps of:
the computer system determining a relationship between an owner of an account and a user by using a knowledge graph;
the computer system determining a pattern of purchases made by the user by using a machine learning module; and
based on (i) the relationship between the owner of the account and the user and (ii) the pattern of the purchases, the computer system dynamically granting a security permission to the user for a use of the account.

10. The computer program product of claim 9, wherein the account is an electronic payment account, and wherein the dynamically granting the security permission includes:
determining one or more authorized categories of items that the user is authorized to purchase based on the pattern of the purchases and by using multivariate time series clustering;
determining one or more authorized businesses from which the user is authorized to purchase the items, based on the pattern of the purchases and by using the multivariate time series clustering;
determining that the user is initiating a purchase of an item using the electronic payment account;
determining that the item is in a category included in the one or more authorized categories and is being purchased from a business included in the one or more authorized businesses; and
based on the item being in the category included in the one or more authorized categories and the item being purchased from the business included in the one or more authorized businesses, authorizing the purchase of the item by the user.

11. The computer program product of claim 10, wherein the method further comprises:
the computer system determining a maximum cost of one or more purchases that the user is authorized to make based on the pattern of the purchases and by using the multivariate time series clustering; and
the computer system determining that a cost of the purchase of the item does not exceed the maximum cost, wherein the authorizing the purchase of the item by the user is further based on the cost of the purchase of the item not exceeding the maximum cost.

12. The computer program product of claim 11, wherein the method further comprises:
the computer system determining that a first cost of a first purchase initiated by the user using the account exceeds the maximum cost;
responsive to the determining that the first cost exceeds the maximum cost, the computer system sending a notification to the owner of the account about the first cost exceeding the maximum cost;
the computer system receiving an authorization from the owner of the account to allow the user to complete the first purchase, the authorization being in response to the notification;
subsequent to the receiving the authorization, the computer system determining that a second cost of a second purchase initiated by the user using the account exceeds the maximum cost;
the computer system determining that the second cost matches the first cost;
based on the authorization to complete the first purchase and the second cost matching the first cost, the computer system authorizing a completion of the second purchase even though the second cost exceeds the maximum cost, without sending another notification to the owner of the account, and without requiring an authorization by the owner of the account to allow the user to complete the second purchase.

13. The computer program product of claim 9, wherein the method further comprises:
the computer system determining a context of the owner of the account based on data from Internet of Things sensors and information from a calendar service of the owner of the account and by using the machine learning module; and
based on the context of the owner of the account, the computer system determining a time period during which the usage of the account by the user is authorized and a maximum amount that the user is permitted to spend during the usage of the account,
wherein the dynamically granting the security permission is further based on the context of the owner of the account.

14. The computer program product of claim 13, wherein the method further comprises the computer system determining that an analysis of speech of the owner of the account by a natural language processing service and the machine learning module indicates that the owner of the account will likely travel to a location at which the owner of the account will not be in a proximity to the user, wherein the determining the context is further based on the owner being likely to travel to the location at which the owner will not be in the proximity to the user.

15. A computer system comprising:
a central processing unit (CPU);
a memory coupled to the CPU; and
a computer readable storage medium coupled to the CPU, the computer readable storage medium containing instructions that are executed by the CPU via the memory to implement a method comprising the steps of:
the computer system determining a relationship between an owner of an account and a user by using a knowledge graph;
the computer system determining a pattern of purchases made by the user by using a machine learning module; and
based on (i) the relationship between the owner of the account and the user and (ii) the pattern of the purchases, the computer system dynamically granting a security permission to the user for a use of the account.

16. The computer system of claim 10, wherein the account is an electronic payment account, and wherein the dynamically granting the security permission includes:
determining one or more authorized categories of items that the user is authorized to purchase based on the pattern of the purchases and by using multivariate time series clustering;
determining one or more authorized businesses from which the user is authorized to purchase the items, based on the pattern of the purchases and by using the multivariate time series clustering;
determining that the user is initiating a purchase of an item using the electronic payment account;
determining that the item is in a category included in the one or more authorized categories and is being purchased from a business included in the one or more authorized businesses; and
based on the item being in the category included in the one or more authorized categories and the item being purchased from the business included in the one or more authorized businesses, authorizing the purchase of the item by the user.

17. The computer system of claim 16, wherein the method further comprises:
the computer system determining a maximum cost of one or more purchases that the user is authorized to make based on the pattern of the purchases and by using the multivariate time series clustering; and
the computer system determining that a cost of the purchase of the item does not exceed the maximum cost, wherein the authorizing the purchase of the item by the user is further based on the cost of the purchase of the item not exceeding the maximum cost.

18. The computer system of claim 17, wherein the method further comprises:
the computer system determining that a first cost of a first purchase initiated by the user using the account exceeds the maximum cost;
responsive to the determining that the first cost exceeds the maximum cost, the computer system sending a notification to the owner of the account about the first cost exceeding the maximum cost;
the computer system receiving an authorization from the owner of the account to allow the user to complete the first purchase, the authorization being in response to the notification;
subsequent to the receiving the authorization, the computer system determining that a second cost of a second purchase initiated by the user using the account exceeds the maximum cost;
the computer system determining that the second cost matches the first cost;
based on the authorization to complete the first purchase and the second cost matching the first cost, the computer system authorizing a completion of the second purchase even though the second cost exceeds the maximum cost, without sending another notification to the owner of the account, and without requiring an authorization by the owner of the account to allow the user to complete the second purchase.

19. The computer system of claim 15, wherein the method further comprises:
the computer system determining a context of the owner of the account based on data from Internet of Things sensors and information from a calendar service of the owner of the account and by using the machine learning module; and
based on the context of the owner of the account, the computer system determining a time period during which the usage of the account by the user is authorized and a maximum amount that the user is permitted to spend during the usage of the account,
wherein the dynamically granting the security permission is further based on the context of the owner of the account.

20. The computer system of claim 19, wherein the method further comprises the computer system determining that an analysis of speech of the owner of the account by a natural language processing service and the machine learning module indicates that the owner of the account will likely travel to a location at which the owner of the account will not be in a proximity to the user, wherein the determining the context is further based on the owner being likely to travel to the location at which the owner will not be in the proximity to the user.
